(19) United States
(12) Patent Application Publication
(10) Pub. No.: US 2025/0080559 A1
(43) Pub. Date: Mar. 6, 2025

(54) Computer-Implemented Methods and Computer Systems for Maintaining Information Security Infrastructure of an Entity

(71) Applicant: Varun Kumar Pandey, San Ramon, CA (US)

(72) Inventor: Varun Kumar Pandey, San Ramon, CA (US)

(73) Assignee: Varun Kumar Pandey, San Ramon, CA (US)

(21) Appl. No.: 18/801,004

(22) Filed: Aug. 12, 2024

Related U.S. Application Data
(60) Provisional application No. 63/580,440, filed on Sep. 5, 2023.

(51) Int. Cl. H04L 9/40

(52) U.S. Cl. CPC H04L 63/1425; H04L 63/1433

(57) ABSTRACT

A computer implemented method for maintaining information security infrastructure of an entity, includes accessing a cascading classification schema comprising a plurality of levels of classifications indicative of critical security controls, identifying a plurality of Key Risk Indicators (KRIs) and assigning a plurality of respective KRI weight values, a plurality of respective first KRI threshold values, and a plurality of respective second KRI threshold values to the plurality of respective KRIs, assigning the plurality of KRIs to the lowest level of classification, defining a plurality of data points corresponding to the plurality of KRIs, determining a plurality of KRI score values corresponding to the plurality of respective KRIs by comparing a plurality of data values associated with the plurality of respective data points, with the plurality of first KRI threshold values and the plurality of second KRI threshold values, and determining a cascading schema of aggregate scores.

### CROSS REFERENCE TO RELATED APPLICATION

The present non-provisional application claims the benefit of priority to provisional patent application No. 63/580,440, filed on Sep. 5, 2023, entitled “COMPUTER-IMPLEMENTED METHODS AND COMPUTER SYSTEMS FOR MAINTAINING INFORMATION SECURITY INFRASTRUCTURE OF AN ENTITY”, the entire contents of which are hereby expressly incorporated by reference.

### TECHNICAL FIELD

The present invention relates generally to information and data security. More specifically, the present invention relates to the diagnosis and maintenance of the information security infrastructure of an entity, such as in an organizational setup.

### BACKGROUND ART

Information security is defined by the US Department of Commerce through the National Institute of Standards and Technology (NIST) as the protection of information and information systems from unauthorized access, use, disclosure, disruption, modification, or destruction to ensure confidentiality, integrity, and availability. Traditional components of an information security infrastructure encompass several key elements:

General Protection: This includes maintaining a registry of IP addresses and physical locations of end-point devices such as computers, smartphones, printers, and routers. It also involves protecting these devices with antivirus software, firewalls, malware protection, DNS filtering, and email phishing solutions. Additionally, the implementation of password protection policies, Lightweight Directory Access Protocol (LDAP) within a local network, secured storage data backups, network firewalls, external vulnerability scanners, and end-point encryption (SSL or TLS) and hashing infrastructure are critical. Real-time generation of single-use encryption keys further enhances security.
Hardware Implementation: This aspect covers ensuring that servers are located in access-controlled environments and incorporating locking devices and Hardware Security Modules (HSMs) in end-point devices, servers, and data storage devices. Implementing power backup systems and disabling unused or unauthorized data ports in devices and servers also contribute to robust hardware security.
Network Level Implementation: This involves the use of virtual devices and networks, such as containers, hypervisors, virtual machines, and Virtual Private Networks (VPNs). Network segregation, dividing a local network into multiple levels and segments, deploying firewalls, and utilizing encryption keys and hashes for security handshakes between these segments are important measures. Secure communication protocols, such as TCP/IP, IPv6, IPSEC, and SSH Tunneling, are also implemented.
Operational Security: Upgrading all nodes, including end-point devices and servers, with the latest security patches and deploying state-of-the-art cybersecurity technologies like blockchain and Artificial Intelligence (AI) are crucial for maintaining operational security.
Crisis Management: This includes maintaining a skilled cybersecurity team capable of addressing network vulnerabilities and data breaches and continuously upgrading their skills. Establishing a hotline or email group for employees to report identified crises is also part of an effective crisis management strategy.

Common threats to information security encompass cyber-attacks such as Denial of Service (DoS) attacks and Man-in-the-Middle (MITM) attacks, unauthorized access, and data breaches. These threats can lead to information leakage, loss of customer trust, competitive edge, reputational damage, corporate or individual penalties, and overall depreciation in company valuation and stock prices. The FBI Internet Crime Report for 2020 indicated a significant increase in reported losses, rising from $1.4 billion in 2017 to $4.2 billion in 2020. Therefore, maintaining a functional information security infrastructure is imperative for organizations.

Information security concerns typically include social engineering (manipulation of company personnel), third-party exposure (data sharing with vendors and clients), patch management (continuous security infrastructure upgrades), ransomware attacks (network breaches where data is held hostage for payment), malware (malicious software or firmware), and general data vulnerabilities (stemming from the aforementioned issues).

To maintain investor and customer confidence, organizations often adhere to information security management systems defined by Standard Setting Organizations (SSOs) such as the International Organization for Standardization (ISO) and NIST. However, the definitions of these systems are continually updated to keep pace with the rapid advancements in information technology. Consequently, organizations must constantly monitor their information security infrastructures, identify gaps and vulnerabilities, and mitigate potential risks to ensure robust information security.

### OBJECTS OF THE INVENTION

Some of the objects of the invention are as follows:

It is an object of the present invention to provide computer-implemented methods and computer systems for maintaining the information security infrastructure of an entity such as an organization or a firm.

It is another object of the present invention to identify Key Risk Indicators (KRIs) and corresponding data points based upon a cascading classification schema of critical security controls.

It is another object of the present invention to determine a cascading schema of aggregate scores indicative of the robustness of the information security infrastructure of the entity.

It is another object of the present invention to provide a Graphic User Interface (GUI) providing visual representations of the state and health of the information security infrastructure of the entity.

It is also an object of the invention to perform gap analysis wherever vulnerabilities exist and provide insights to users for filling in the gaps and resolving vulnerabilities.

### SUMMARY OF THE INVENTION

According to a first aspect of the present invention, there is provided a computer-implemented method for maintaining information security infrastructure of an entity. The computer-implemented method includes accessing a cascading classification schema comprising a plurality of levels of classifications indicative of critical security controls for the information security infrastructure, each one the plurality of levels of classifications including one or more classes defined by one or more respective class definitions. The plurality of levels of classifications further includes at least a penultimate level of classification comprising one or more penultimate level classes, and a lowest level of classification comprising one or more lowest level classes assigned to the one or more penultimate level classes. The one or more lowest level classes are assigned one or more respective lowest level weight values, one or more respective first lowest level threshold values, and one or more respective second lowest level threshold values. Also, the one or more penultimate level classes are assigned one or more respective penultimate level weight values, one or more respective first penultimate level threshold values, and one or more respective second penultimate level threshold values. The computer-implemented method further includes identifying a plurality of Key Risk Indicators (KRIs) and assigning a plurality of respective KRI weight values, a plurality of respective first KRI threshold values, and a plurality of respective second KRI threshold values to the plurality of respective KRIs, based on the accessed cascading classification schema. Further, the computer-implemented method includes assigning the plurality of KRIs to the lowest level of classification, wherein each lowest level class is assigned at least one KRI. The computer-implemented method further includes defining a plurality of data points corresponding to the plurality of KRIs, wherein each one of the plurality of KRIs has been assigned at least one datapoint. Furthermore, the computer-implemented method includes determining a plurality of KRI score values corresponding to the plurality of respective KRIs by comparing a plurality of respective data values associated with the plurality of respective data points, with the plurality of first KRI threshold values and the plurality of second KRI threshold values. Also, the computer-implemented method includes determining a cascading schema of aggregate scores comprising a plurality of levels of aggregate scores. The plurality of levels of aggregate scores includes at least a lowest level of aggregate scores corresponding to the lowest level of classification, the lowest level of aggregate scores comprising one or more lowest level aggregate scores, such that, for a lowest level class a respective lowest level aggregate score is determined by comparing a weighted average of one or more KRI score values associated with respective one or more KRIs belonging to the lowest level class with a first lowest level threshold value and a second lowest level threshold value associated with the lowest level class, and a penultimate level of aggregate scores corresponding to the penultimate level of classification, the penultimate level of aggregate scores comprising one or more penultimate level aggregate scores, such that, for a penultimate level class a respective penultimate level aggregate score determined by comparing a weighted average of one or more lowest level aggregate scores associated with respective one or more lowest level classes belonging to the penultimate level class with a first penultimate level threshold value and a second penultimate level threshold value associated with the penultimate level class.

In one embodiment of the invention, the cascading classification schema is accessed from an information security standard defined by a Standard Setting Organization (SSO).

In one embodiment of the invention, the computer-implemented method further includes displaying the one or more penultimate level classes with the one or more penultimate level aggregate scores in a first Graphic User Interface (GUI) component, through a display unit of a user computing device.

In one embodiment of the invention, the computer-implemented method further includes displaying the one or more lowest level classes with the one or more lowest level aggregate scores in a second GUI component, through a display unit of a user computing device.

In one embodiment of the invention, the computer-implemented method further includes determining one or more highest level aggregate score values corresponding to respective one or more highest level classes of a highest level of classification of the cascading classification schema, assigning one or more highest level weights, a first overall threshold value, and a second overall threshold value to the respective one or more highest level classes, and determining an overall aggregate score by comparing a weighted average of the one or more highest level aggregate scores with the first overall threshold value and the second overall threshold value.

In one embodiment of the invention, the computer-implemented method further includes displaying, on a display unit, the determined current overall aggregate score along with a target overall aggregate score and a standard overall aggregate score for an industry to which the entity belongs.

According to a second aspect of the present invention, there is provided a computer system for maintaining information security infrastructure of an entity. The computer system includes a processor, and a memory unit operably connected to the processor, the memory unit comprising machine readable instructions, that when executed by the processor, enable the processor to access a cascading classification schema comprising a plurality of levels of classifications indicative of critical security controls for the information security infrastructure, each one the plurality of levels of classifications comprising one or more classes defined by one or more respective class definitions. The plurality of levels of classifications further includes at least a penultimate level of classification comprising one or more penultimate level classes, and a lowest level of classification comprising one or more lowest level classes assigned to the one or more penultimate level classes. The one or more lowest level classes are assigned one or more respective lowest level weight values, one or more respective first lowest level threshold values, and one or more respective second lowest level threshold values. Also, the one or more penultimate level classes are assigned one or more respective penultimate level weight values, one or more respective first penultimate level threshold values, and one or more respective second penultimate level threshold values. The processor is further enabled to identify a plurality of Key Risk Indicators (KRIs) and assign a plurality of respective KRI weight values, a plurality of respective first KRI threshold values, and a plurality of respective second KRI threshold values to the plurality of respective KRIs, based on the accessed cascading classification schema. Further, the processor is enabled to assign the plurality of KRIs to the lowest level of classification, wherein each lowest level class is assigned at least one KRI. The processor is further enabled to define a plurality of data points corresponding to the plurality of KRIs, wherein each one of the plurality of KRIs has been assigned at least one datapoint. Furthermore, the processor is enabled to determine a plurality of KRI score values corresponding to the plurality of respective KRIs by comparing a plurality of respective data values associated with the plurality of respective data points, with the plurality of first KRI threshold values and the plurality of second KRI threshold values. Also, the processor is enabled to determine a cascading schema of aggregate scores comprising a plurality of levels of aggregate scores. The plurality of levels of aggregate scores includes at least a lowest level of aggregate scores corresponding to the lowest level of classification, the lowest level of aggregate scores comprising one or more lowest level aggregate scores, such that, for a lowest level class a respective lowest level aggregate score is determined by comparing a weighted average of one or more KRI score values associated with respective one or more KRIs belonging to the lowest level class with a first lowest level threshold value and a second lowest level threshold value associated with the lowest level class, and a penultimate level of aggregate scores corresponding to the penultimate level of classification, the penultimate level of aggregate scores comprising one or more penultimate level aggregate scores, such that, for a penultimate level class a respective penultimate level aggregate score determined by comparing a weighted average of one or more lowest level aggregate scores associated with respective one or more lowest level classes belonging to the penultimate level class with a first penultimate level threshold value and a second penultimate level threshold value associated with the penultimate level class.

In one embodiment of the invention, the processor is enabled to access the cascading classification schema from an information security standard defined by a Standard Setting Organization (SSO) server.

In one embodiment of the invention, the processor is further enabled to display the one or more penultimate level classes with the one or more penultimate level aggregate scores in a first Graphic User Interface (GUI) component, through a display unit of a user computing device.

In one embodiment of the invention, the processor is further enabled to display the one or more lowest level classes with the one or more lowest level aggregate scores in a second GUI component, through a display unit of a user computing device.

In one embodiment of the invention, the processor is further enabled to determine one or more highest level aggregate score values corresponding to respective one or more highest level classes of a highest level of classification of the cascading classification schema, assign one or more highest level weights, a first overall threshold value, and a second overall threshold value to the respective one or more highest level classes, and determine an overall aggregate score by comparing a weighted average of the one or more highest level aggregate scores with the first overall threshold value and the second overall threshold value.

In one embodiment of the invention, the processor is further enabled to display, on a display unit, the determined current overall aggregate score along with a target overall aggregate score and a standard overall aggregate score for an industry to which the entity belongs.

According to a third aspect of the present invention, there is provided a non-transitory computer-readable medium storing computer-executable instructions for maintaining information security infrastructure of an entity. The computer-executable instruction configured for accessing a cascading classification schema comprising a plurality of levels of classifications indicative of critical security controls for the information security infrastructure, each one the plurality of levels of classifications including one or more classes defined by one or more respective class definitions. The plurality of levels of classifications further includes at least a penultimate level of classification comprising one or more penultimate level classes, and a lowest level of classification comprising one or more lowest level classes assigned to the one or more penultimate level classes. The one or more lowest level classes are assigned one or more respective lowest level weight values, one or more respective first lowest level threshold values, and one or more respective second lowest level threshold values. Also, the one or more penultimate level classes are assigned one or more respective penultimate level weight values, one or more respective first penultimate level threshold values, and one or more respective second penultimate level threshold values. The computer-executable instruction further configured for identifying a plurality of Key Risk Indicators (KRIs) and assigning a plurality of respective KRI weight values, a plurality of respective first KRI threshold values, and a plurality of respective second KRI threshold values to the plurality of respective KRIs, based on the accessed cascading classification schema. Further, the computer-executable instruction configured for assigning the plurality of KRIs to the lowest level of classification, wherein each lowest level class is assigned at least one KRI. The computer-executable instruction further configured for defining a plurality of data points corresponding to the plurality of KRIs, wherein each one of the plurality of KRIs has been assigned at least one datapoint. Furthermore, the computer-executable instruction configured for determining a plurality of KRI score values corresponding to the plurality of respective KRIs by comparing a plurality of respective data values associated with the plurality of respective data points, with the plurality of first KRI threshold values and the plurality of second KRI threshold values. Also, the computer-executable instruction configured for determining a cascading schema of aggregate scores comprising a plurality of levels of aggregate scores. The plurality of levels of aggregate scores includes at least a lowest level of aggregate scores corresponding to the lowest level of classification, the lowest level of aggregate scores comprising one or more lowest level aggregate scores, such that, for a lowest level class a respective lowest level aggregate score is determined by comparing a weighted average of one or more KRI score values associated with respective one or more KRIs belonging to the lowest level class with a first lowest level threshold value and a second lowest level threshold value associated with the lowest level class, and a penultimate level of aggregate scores corresponding to the penultimate level of classification, the penultimate level of aggregate scores comprising one or more penultimate level aggregate scores, such that, for a penultimate level class a respective penultimate level aggregate score determined by comparing a weighted average of one or more lowest level aggregate scores associated with respective one or more lowest level classes belonging to the penultimate level class with a first penultimate level threshold value and a second penultimate level threshold value associated with the penultimate level class.

In one embodiment of the invention, the cascading classification schema is accessed from an information security standard defined by a Standard Setting Organization (SSO).

In one embodiment of the invention, the computer-executable instruction further configured for displaying the one or more penultimate level classes with the one or more penultimate level aggregate scores in a first Graphic User Interface (GUI) component, through a display unit of a user computing device.

In one embodiment of the invention, the computer-executable instruction further configured for displaying the one or more lowest level classes with the one or more lowest level aggregate scores in a second GUI component, through a display unit of a user computing device.

In one embodiment of the invention, the computer-executable instruction further configured for determining one or more highest level aggregate score values corresponding to respective one or more highest level classes of a highest level of classification of the cascading classification schema, assigning one or more highest level weights, a first overall threshold value, and a second overall threshold value to the respective one or more highest level classes, and determining an overall aggregate score by comparing a weighted average of the one or more highest level aggregate scores with the first overall threshold value and the second overall threshold value.

In one embodiment of the invention, the computer-executable instruction further configured for displaying, on a display unit, the determined current overall aggregate score along with a target overall aggregate score and a standard overall aggregate score for an industry to which the entity belongs.

In the context of the specification, the term “processor” refers to one or more of microprocessors, a Digital Signal Processor (DSP), a System-on-a-Chip (SOC), a microcontroller, a general-purpose processor, a Field Programmable Gate Array (FPGA) or an Application Specific Integrated Circuit (ASIC), and the like.

In the context of the specification, the phrase “memory unit”, refers to volatile storage memory, such as Static Random Access Memory (SRAM) and Dynamic Random Access Memory (DRAM) of types such as Asynchronous DRAM, Synchronous DRAM, Double Data Rate SDRAM, Rambus DRAM, and Cache DRAM, etc.

In the context of the specification, the phrases “storage device” or “database(s)” refer to a non-volatile storage device including non-volatile memory such as EPROM, EEPROM, flash memory, or the like.

In the context of the specification, the phrase “communication interface” refers to a device or a module enabling direct connectivity via wires and connectors such as USB, HDMI, VGA, or wireless connectivity such as Bluetooth or Wi-Fi, or Local Area Network (LAN) or Wide Area Network (WAN) implemented through TCP/IP, IEEE 802.x, GSM, CDMA, LTE, or other equivalent protocols.

In the context of the specification, the term “firewall” refers to a network security device that monitors incoming and outgoing network traffic and decides whether to allow or block specific traffic based on a defined set of security rules. Firewalls establish a barrier between secured and controlled internal networks that can be trusted and untrusted outside networks, such as the Internet. The firewall can be implemented at a node level, referred to as a “host firewall” which protects every individual device from malicious content in incoming or outgoing traffic. Alternately, the firewall can be implemented at a network level, referred to as a “network firewall” which monitors traffic between two disparate networks, such as between a local intranet and the Internet.

In the context of the specification, the phrase “Domain Name System (DNS) filtering” refers to blocking a set of Internet Protocol (IP) addresses from being accessed by a node in a computer network by configuring an internal DNS resolver with a block list or an allow list of IP addresses.

In the context of the specification, the phrase “DNS resolver” refers to a network server that receives a DNS query including a domain name, from a node in a computer network, identifies one or more IP addresses associated with the domain name, and transmits the identified one or more IP addresses to the node. The DNS resolver can be further utilized for DNS filtering by configuring the DNS resolver with the block list or the allow list of the IP addresses.

### BRIEF DESCRIPTION OF THE ACCOMPANYING DRAWINGS

The accompanying drawings depict the optimal approach for implementing the invention as it is currently conceived and described below. To provide a comprehensive understanding of the present invention, please refer to the detailed explanation of the preferred embodiments, which are accompanied by the drawings. Throughout the figures in the drawings, similar reference letters and numerals are utilized to denote corresponding parts.

FIG. 1 illustrates an example environment of computing and peripheral devices, in which several embodiments of the present invention may be implemented;

FIG. 2 illustrates a computer-implemented method for maintaining information security infrastructure of an entity, in accordance with an embodiment of the present invention;

FIG. 3 illustrates a login page of a Graphic User Interface (GUI) of an implementation of the present invention, in accordance with an embodiment;

FIG. 4 illustrates a multi-step authentication page of the GUI of the implementation of the present invention, in accordance with an embodiment;

FIG. 5 illustrates an executive dashboard page of the GUI of the implementation of the present invention, in accordance with an embodiment;

FIG. 6 illustrates a configuration manager page of the GUI of the implementation of the present invention, in accordance with an embodiment; and

FIG. 7 illustrates a super administrator page of the GUI of the implementation of the present invention, in accordance with an embodiment.

FIG. 8 illustrates a connector capabilities page of the GUI of the implementation of the present invention, in accordance with an embodiment.

FIG. 9 illustrates calibration capability page of the GUI of the implementation of the present invention, in accordance with an embodiment.

FIG. 10 illustrates a service organization control (SOC2) readiness capability of the GUI of the implementation of the present invention, in accordance with an embodiment.

FIG. 11 illustrates a risk scenario generation capability of the GUI of the implementation of the present invention, in accordance with an embodiment.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

Embodiments of the present invention provide computer-implemented methods and computer systems for maintaining information security infrastructure of an entity. The present invention includes identification of several Key Risk Identifiers (KRIs) in consonance with several critical security controls for maintaining an optimal health of the information security infrastructure. Furthermore, KRIs are identified in a manner that they are also drivers for Key Performance Indicators (KPIs) pertaining to processes followed by the entity. A respective KRI score value is determined for each corresponding identified KRI from several data points pertinent to the information security infrastructure. In that regard, each datapoint has a respective data value assigned to the datapoint. Furthermore, each KRI is also assigned a respective weight. The KRIs are then divided into several classes of a predefined classification schema. In that regard, the predefined classification schema may be accessed from an information security standard defined by a Standard Setting Organization (SSO) such as National Institute of Standards and Technology (NIST), Center for Internet Security (CIS), Cybersecurity Maturity Model Certification (CMMC), and International Organization for Standardization (ISO).

The predefined classification schema may be a cascading classification schema having several levels of classes, sub-classes, groups, lists, and so forth. At the lowest level of the predefined classification schema, each one of the classes may be uniquely or otherwise assigned at least one KRI. Aggregate scores respective to each one of the classes of the lowest level of classification schema may be determined by comparing weighted averages of respective KRI values of KRIs belonging to the classes of the lowest level with respective upper and lower threshold values assigned to each one of the classes of the lowest level. In the cascading arrangement of the classification schema, each class of the lowest level of the classification schema may also be assigned respective lowest-level class weights. Further, the classes of the lowest level may be divided amongst classes of a penultimate level of the cascading classification schema. Aggregate scores respective to classes of the penultimate level may be determined by comparing weighted averages of the aggregate scores of the respective lowest level classes belonging to the classes of the penultimate level with respective upper and lower threshold values assigned to each one of the classes of the penultimate level. The same methodology may be extended to any number of levels defined in the classification schema selected, for example from an information security standard. Further, gap analysis may be performed based on determined aggregate scores to identify security vulnerabilities and provide insights to fill in the identified gaps and resolve security vulnerabilities.

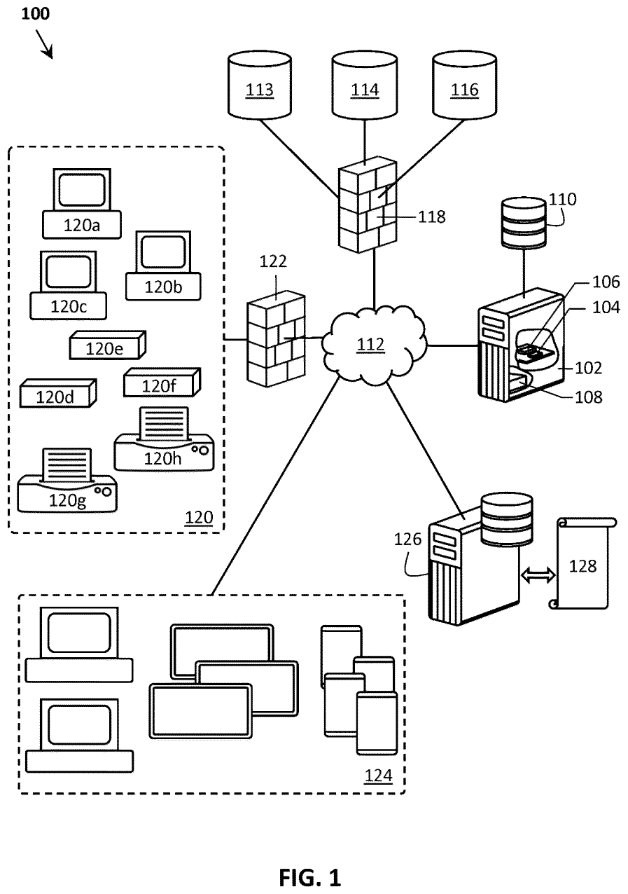

Several embodiments of the present invention will now be elucidated in detail with references to FIGS. 1-7. The present invention in the following discussion has primarily been described using the NIST Cybersecurity Framework as a reference. Moreover, the discussion has been extended to the implementation of the present invention to other widely accepted standards in the information security space. However, a person skilled in the art would appreciate that the present invention as presented below is not limited only to the information security standards presented in the following discussion but can also be extended to several other equivalent information security standards, processes, and practices, without departing from the scope of the invention.

FIG. 1 illustrates an example environment 100 of computing and peripheral devices, in which several embodiments of the present invention may be implemented. The environment 100 includes an application server 102 that hosts at least a part of an application code for the implementation of several embodiments of the present invention. In that regard, the application server 102 includes a processor 104, a memory unit 106, and a communication interface 108. The application server 102 is further operably connected to a storage device 110. The storage device 110 may be configured to store application code pertaining to the coded application and other data received or generated during the working of the invention. During run-time, at least a part of the application code residing on the storage device 110 is copied into the memory unit 106. Further, the copied part of the application code is executed by the processor 104 for implementation of the several embodiments of the present invention.

The application server 102 is securely connected to a communication network 112. In that regard, the application server 102 may be equipped with hash functions and public key infrastructure such as Transport Layer Security (TLS). The communication network 112 may be an internal intranet of an entity. In such a scenario, the application server 102 may be a local server, and the communication network 112 may be implemented through protocols such as Ethernet (IEEE 802.3) and/or Wireless Fidelity (Wi-Fi) (IEEE 802.11). In several alternate embodiments, the application server 102 may be a remote or a cloud-based server. In that regard, the communication network 112 may be a Wide Area Network (WAN) such as the Internet, implemented using IEEE 802.x, HSDPA, HSPA, LTE, Optical Fibers, etc.

Further, securely connected to the communication network 112 are a plurality of information security databases 113, 114, and 116 through a first firewall 118. The plurality of information security databases 113, 114, and 116 may include several data points and corresponding data values pertaining to the state of the information security infrastructure of the entity. Furthermore, a plurality of assets 120 of the entity, such as computer systems 120a, 120b, 120c, network routers 120d, 120e, and 120f, and printers 120g and 120h are securely connected to the communication network 112 through a second firewall 122.

Further connected to the communication network 112 are a plurality of user computing devices 124. The user computing devices 124 may include desktop PCs, tablet PCs, and smartphones. Several users at different levels of the hierarchy of the entity may be able to access several features of the present invention using Graphic User Interfaces (GUIs) made available on respective user computing devices of the users. Access control through username and password protection and assigning distinct privileges to distinct users may be implemented to prevent data and information belonging to the entity from being accessed by unauthorized personnel. Also, connected to the application server 102 is a Standard Setting Organization (SSO) server 126 that is capable of providing access to an applicable information security standard 128 for the working of the present invention.

Several embodiments of the present invention will now be elucidated using the example environment 100 as a reference. However, a person skilled in the art would appreciate that the invention can be applied to several alternate device environments without departing from the scope of the present invention. Several method steps described to be performed by the application server 102 may be performed by the processor 104 executing machine-readable code from the memory unit 106. Furthermore, communications between the application server 102 and other computing devices through the communication network 112 may be performed by leveraging the communication interface 108.

Most of the well-known information security standards define a cascading classification schema including several levels of classifications. For example, NIST defines five (5) functions (Identify, Protect, Detect, Respond, Recover), twenty-three (23) categories, and one hundred and eight (108) sub-categories in a Framework core of its Cybersecurity Framework. Centre for Internet Security Controls (CIS) defines around twenty (20) critical security controls divided into three levels or categories. Table 1 below illustrates an example distribution of the critical security controls of the CIS standard.

TABLE 1

| Basic | Foundational | Organization |
|---|---|---|
| Inventory and Control | Email and web browser | Implement a security |
| of Software Assets | protection | awareness and training |
| | | program |
| Inventory and Control | Malware defenses | Application software |
| of Hardware Assets | | security |
| Continuous | Limitation and control | Incident response and |
| Vulnerability | of network ports, | management |
| Management | protocols and services | |
| Controlled use of | Data recovery | Penetration test and |
| administrative | capabilities | red team exercises |
| privileges | | |
| Secure configuration | Secure configuration | |
| for hardware and | for network devices, | |
| software on mobile | such as firewalls, | |
| devices, laptops, | routers, and switches | |
| workstations and | | |
| servers | | |
| Maintenance, | Boundary Defense | |
| monitoring, and | | |
| analysis of audit | | |
| logs | | |
| | Data protection | |
| | Controlled access based | |
| | on need-to-know | |
| | Wireless access control | |
| | Account monitoring and | |
| | control | |

CMMC Framework defines five (5) practices and five (5) processes. The five practices include:
1. Basic Cyber Hygiene
2. Intermediate Cyber Hygiene
3. Good Cyber Hygiene
4. Proactive
5. Advanced/Progressive

The five processes include:
1. Performed
2. Documented
3. Managed
4. Reviewed
5. Optimizing

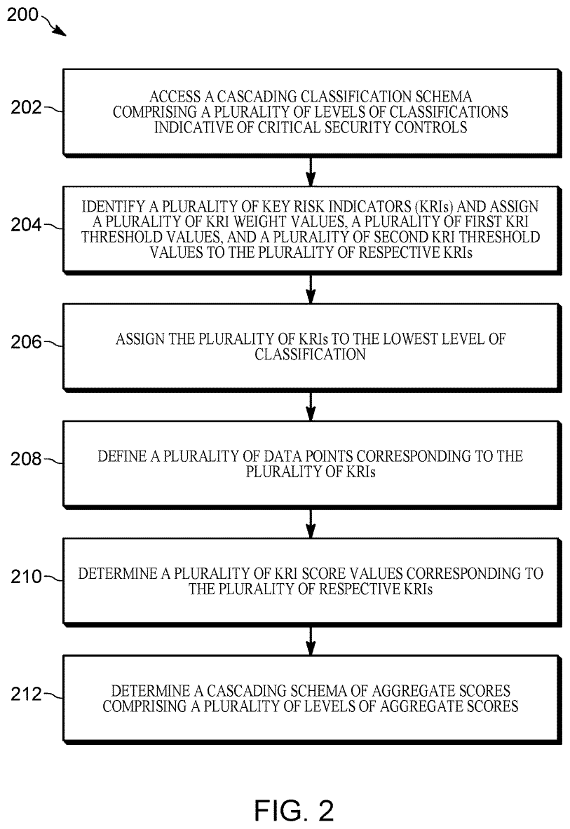

Similarly, ISO 27001 defines fourteen (14) control areas and one hundred fourteen (114) controls. In that regard, it can be observed that most of the widely accepted security standards define critical security controls at several levels of classification having a cascading classification schema. Therefore, the following discussion in regard to FIG. 2 has been elucidated for the implementation of the present invention for standards having the cascading classification schema. It is therefore assumed that the cascading classification schema will at least include a lowest level of classification and a penultimate level of classification. However, a person skilled in the art would appreciate that the following discussion in regard to FIG. 2 can be extended to a cascading classification schema containing more than two levels of classification, equivalently, without departing from the scope of the invention.

FIG. 2 illustrates a computer-implemented method 200 (hereinafter also referred to as “the method 200”) for maintaining information security infrastructure of an entity, in accordance with an embodiment of the present invention. The method 200 begins at Step 202 when the processor 104 accesses a cascading classification schema comprising a plurality of levels of classifications indicative of critical security controls for the information security infrastructure. The processor 104 accesses the cascading classification schema from the information security standard 128 defined by the SSO server 126. Further, each one of the plurality of levels of classifications includes one or more classes defined by one or more respective class definitions.

In that manner, the plurality of levels of classifications at least includes a penultimate level of classification and a lowest level of classification. The penultimate level of classification includes one or more penultimate level classes, and the lowest level of classification includes one or more lowest-level classes. Further, the processor 104 assigns one or more respective lowest level weight values, one or more respective first lowest level threshold values, and one or more respective second lowest level threshold values to the one or more lowest level classes. Also, the processor 104 assigns one or more respective penultimate level weight values, one or more respective first penultimate level threshold values, and one or more respective second penultimate level threshold values to the one or more penultimate level classes.

At Step 204, the processor 104 either receives as an input or determines automatically a plurality of Key Risk Indicators (KRIs) pertinent to the information security architecture of the entity. The identification of the plurality of KRIs is also dependent upon the accessed cascading classification schema. In that regard, the plurality of KRIs may be provided using the user computing devices 124 and may be identified after discussions between several experienced and skilled personnel belonging to the information security space. In several alternate embodiments, the application code may include the implementation of Artificial Intelligence (AI) and Machine Learning (ML) enabling the processor 104 to sweep the information security infrastructure and other sources such as the plurality of information security databases 113, 114, and 116, and the Internet to automatically identify KRIs pertinent to the information security of the entity. Furthermore, the processor 104 assigns a plurality of respective KRI weight values, a plurality of respective first KRI threshold values, and a plurality of respective second KRI threshold values to the plurality of respective KRIs, based on the accessed cascading classification schema. The threshold values may be used to indicate performances as “lagging” or “leading”.

At Step 206, the plurality of KRIs is assigned to the lowest level of classification. In that regard, each lowest level class of the one or more lowest level classes is assigned at least one KRI. The assignment of the plurality of KRIs to the one or more lowest-level classes may again be performed by skilled personnel based on their knowledge and experience with the information security space.

Alternatively, the assignment may be automated using Al and ML algorithms.

At Step 208, in a manner similar to the identification of the plurality of KRIs, the processor 104 receives definitions (from the plurality of information security databases 113, 114, and/or 116, and the Internet, or from skilled personnel using the user computing devices 124) of a plurality of data points corresponding to the plurality of identified KRIs. Alternately, the processor 104 may automatically define the plurality of data points using Al and ML algorithms. In a typical embodiment, there may be as large as four-hundred fifty (450) KRIs identified and seven hundred (700) data points defined. Furthermore, a plurality of data values corresponding to the plurality of respective data points are also determined and/or received by the processor 104. The plurality of KRIs is assigned the plurality of data points such that each one of the plurality of KRIs is assigned at least one data point. Table 2 illustrates an example list of KRIs vis-à-vis assigned data points.

TABLE 2

| Key Risk Indicators (KRIs) | Data Points Required |
|---|---|
| Percentage of critical assets that follow | Total number of critical systems |
| processes defined by the organization to | |
| manage user access | |
| Percentage of critical systems that follow | Total number of critical systems that do not |
| processes defined by the organization to | follow standards set by the organization for |
| manage user access | user access |
| Percentage of leavers whose access is not | Total number of leavers in last 6 months |
| terminated within the established timelines | Total number of past 6 months leavers whose |
| | active access still exists into the system |
| | passed established timeline |
| Percentage of transfers whose access is not | Total number of transfers in last 6 months |
| updated within the established timelines | Total number of past 6 months transfers |
| | whose still carry previous role accesses |
| | passed established timeline |
| Percentage of critical systems for which | Total number of critical systems |
| privileged accounts are not managed using a | Total number of critical systems whose |
| password vault solution | privilege accounts have been provisioned via |
| | CyberArk or similar password vault tools |
| Percentage of critical assets that do not use | Total number of critical systems that are |
| the access management processes and tools | allowing bypassing of organization's standard |
| provided by the organization | access authorization mechanism |
| Percentage of privileged accounts that use | Total number of user accounts |
| multi-factor authentication | Total number of user accounts access |
| | provisioned via multi factor authentication |
| Percentage of critical applications that do not | Total number of critical applications |
| use authentication mechanisms required by | Total number of critical applications that are |
| the organization | allowing bypassing of established access |
| | authorization mechanism |
| Total number of shared accounts which | Total number of shared (e.g., application, |
| cannot be traced back to a specific individual | service) accounts |
| | Total number of shared accounts that do not |
| | have owners assigned |
| Percentage of network devices that do not | Total number of remote access points |
| require two factor authentication to provide | Total number of remote access points that do |
| remote access to privileged and non- | not require multi-factor authentication |
| privileged accounts | |
| Percentage of critical assets for which the | Total number of critical system that do not |
| strength of authentication mechanism does not | meet established authentication requirements |
| meet the established requirements | for critical systems |
| Percentage of access points that do not utilize | Total number of network access points such |
| Network Access Control (NAC) to | as WAP, office LAN ports |
| authenticate devices to connect to the | Total number of access points that do not |
| organization's network | utilize Network Access Control (NAC) to |
| | authenticate devices connecting organization's |
| | network |
| Percentage of privileged accounts that do not | Total number of privileged accounts |
| use multi-factor authentication | Total number of privileged accounts without |
| | multi-factor authentication |
| Percentage of critical assets for use | Total critical assets that uses file transfer |
| unencrypted file transfers for identity | Total number of critical assets that use |
| federation | unencrypted file transfer for identity |
| | federation |
| Percentage of critical assets for which | Total number of critical applications |
| passwords are transmitted in clear text | Total number of critical applications for |
| | which clear text passwords are used for |
| | authentication |
| Percentage of critical systems that do not use | Total number of critical systems that do not |
| encrypted channels for the transmission of | use encrypted channels for transmission of |
| passwords over a network. | passwords over the network |
| Percentage of critical assets that do not | Total number of access accounts such as user |
| enforce password requirements established by | account, service account, privileged account, |
| the organization | technical account, generic accounts |
| | Total number of access accounts that do not |
| | enforce established password requirements |
| Number of facilities that do not use badged | Total number of organization's facilities |
| access | Total number of organization's facilities not |
| | mandating badged access |

At Step 210, the processor 104 determines a plurality of KRI score values corresponding to the plurality of respective KRIs from the plurality of data values associated with the plurality of respective data points, the plurality of first KRI threshold values, and the plurality of second KRI threshold values. Table 3 illustrates an example determination of the plurality of KRI score values.

| | | | First | Second | |
|---|---|---|---|---|---|
| | | | KRI | KRI | |
| | KRI | | Thresh- | Thresh- | |
| Key Risk | Weight | Data | old | old | Metric |
| Indicators (KRIs) | Value | Value | Value | Value | Score |
| Percentage of critical | 0.33 | 87% | 90% | 75% | 2 |
| systems that are not | | | | | |
| tracked in the central | | | | | |
| asset inventory solution. | | | | | |
| Percentage of inventoried | 0.33 | 90% | 90% | 70% | 3 |
| devices without assigned | | | | | |
| individuals | | | | | |
| responsible/accountable | | | | | |
| for administering the | | | | | |
| devices. | | | | | |
| Percentage of inventoried | | | | | |
| critical assets without | 0.33 | 91% | 95% | 80% | 2 |
| approved component | | | | | |
| configurations. | | | | | |

At Step 212, the processor 104 determines a cascading schema of aggregate scores comprising a plurality of levels of aggregate scores. The plurality of levels of aggregate scores at least includes a lowest level of aggregate scores corresponding to the lowest level of classification, and a penultimate level of aggregate scores corresponding to the penultimate level of classification. The lowest level of aggregate scores includes one or more lowest-level aggregate scores, and the penultimate level of aggregate scores includes one or more penultimate-level aggregate scores.

In that regard, for a lowest level class, a respective lowest level aggregate score is determined by comparing a weighted average of one or more KRI score values associated with respective one or more KRIs belonging to the lowest level class, with a first lowest level threshold value and a second lowest level threshold value associated with the lowest level class. Table 4 illustrates an example determination of a lowest level aggregate score for a lowest level class.

TABLE 4

| | | | | | First | Second | Lowest |
|---|---|---|---|---|---|---|---|
| | | KRI | KRI | | Lowest | Lowest | Level |
| | Key Risk Indicators | Weight | Score | Weighted | Level | Level | Aggregate |
| Lowest Level Class | (KRIs) | Value | Value | Average | Threshold | Threshold | Score |
| ID.AM-1: | Percentage of | 0.33 | 2 | 78% | 95% | 70% | 2.00 |
| Physical devices | critical systems | | | | | | |
| and systems | that are not | | | | | | |
| within the | tracked in the | | | | | | |
| organization are | central asset | | | | | | |
| inventoried | inventory | | | | | | |
| | solution. | | | | | | |
| | Percentage of | 0.33 | 3 | | | | |
| | inventoried devices | | | | | | |
| | without assigned | | | | | | |
| | individuals | | | | | | |
| | responsible/ | | | | | | |
| | accountable for | | | | | | |
| | administering | | | | | | |
| | the devices. | | | | | | |
| | Percentage of | 0.33 | 2 | | | | |
| | inventoried | | | | | | |
| | critical assets | | | | | | |
| | without approved | | | | | | |
| | component | | | | | | |
| | configurations. | | | | | | |

For a penultimate level class a respective penultimate level aggregate score determined by comparing a weighted average of one or more lowest level aggregate scores associated with respective one or more lowest level classes belonging to the penultimate level class with a first penultimate level threshold value and a second penultimate level threshold value associated with the penultimate level class. Table 5 illustrates an example determination of a penultimate-level aggregate score for a penultimate-level class.

TABLE 5

| | | Lowest | Lowest | | First | Second | Penultimate |
|---|---|---|---|---|---|---|---|
| | | Level | Level | | Penultimate | Penultimate | Level |
| Penultimate | Lowest Level | Aggregate | Weight | Weighted | Level | Level | Aggregate |
| Level Class | Class | Score | Value | Average | Threshold | Threshold | Score |
| Asset | ID.AM-1: | 2.00 | 0.20 | 40% | 85% | 60% | 1.00 |
| Management | Physical devices | | | | | | |
| (ID.AM): | and systems | | | | | | |
| The data, | within the | | | | | | |
| personnel, | organization are | | | | | | |
| devices, | inventoried | | | | | | |
| systems, and | ID.AM-2: | 1.00 | 0.18 | | | | |
| facilities that | Software | | | | | | |
| enable the | platforms and | | | | | | |
| organization | applications | | | | | | |
| to achieve | within the | | | | | | |
| business | organization are | | | | | | |
| purposes are | inventoried | | | | | | |
| identified and | ID.AM-3: | 1.00 | 0.23 | | | | |
| managed | Organizational | | | | | | |
| consistent | communication | | | | | | |
| with their | and data flows are | | | | | | |
| relative | mapped | | | | | | |
| importance to | ID.AM-4: | 1.00 | 0.15 | | | | |
| business | External | | | | | | |
| objectives and the | information | | | | | | |
| organization's | systems are | | | | | | |
| risk strategy. | catalogued | | | | | | |
| | ID.AM-5: | 1.00 | 0.12 | | | | |
| | Resources (e.g., | | | | | | |
| | hardware, | | | | | | |
| | devices, data, and | | | | | | |
| | software) are | | | | | | |
| | prioritized based | | | | | | |
| | on their | | | | | | |
| | classification, | | | | | | |
| | criticality, and | | | | | | |
| | business value | | | | | | |
| | ID.AM-6: | 1.00 | 0.12 | | | | |
| | Cybersecurity | | | | | | |
| | roles and | | | | | | |
| | responsibilities | | | | | | |
| | for the entire | | | | | | |
| | workforce and | | | | | | |
| | third-party | | | | | | |
| | stakeholders (e.g., | | | | | | |
| | suppliers, | | | | | | |
| | customers, | | | | | | |
| | partners) are | | | | | | |
| | established | | | | | | |

In several embodiments of the invention, the processor 104 further displays the one or more penultimate level classes with the one or more penultimate level aggregate scores in a first Graphic User Interface (GUI) component, through display units of the user computing devices 124. In several embodiments of the invention, the processor 104 displays the one or more lowest level classes with the one or more lowest level aggregate scores in a second GUI component, through the display units of the user computing devices 124.

In several embodiments of the invention, the processor 104 further determines one or more highest level aggregate score values corresponding to respective one or more highest level classes of a highest level of classification of the cascading classification schema. Furthermore, the processor 104 assigns one or more highest level weights, a first overall threshold value, and a second overall threshold value to the respective one or more highest level classes. Additionally, the processor 104 determines an overall aggregate score for the entity, by comparing a weighted average of the one or more highest level aggregate scores with the first overall threshold value and the second overall threshold value. In several embodiments of the invention, the processor 104 displays the determined current overall aggregate score along with a target overall aggregate score and a standard overall aggregate score for an industry to which the entity belongs, through the display units of the user computing devices 124.

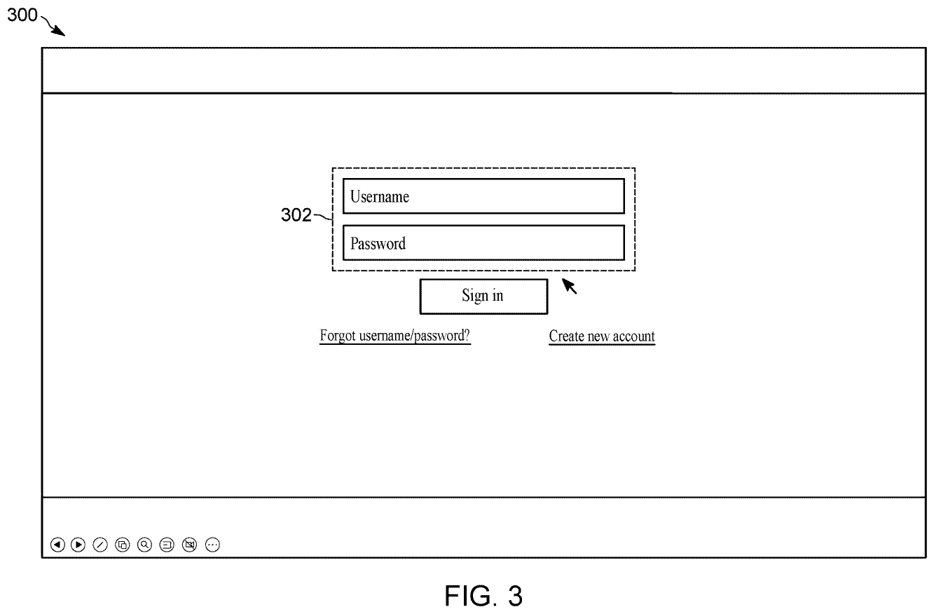

FIG. 3 illustrates a login page 300 of a Graphic User Interface (GUI) of an implementation of the present invention, in accordance with an embodiment. As illustrated, the login page 300 provides prompt 302 to a user for their username and password.

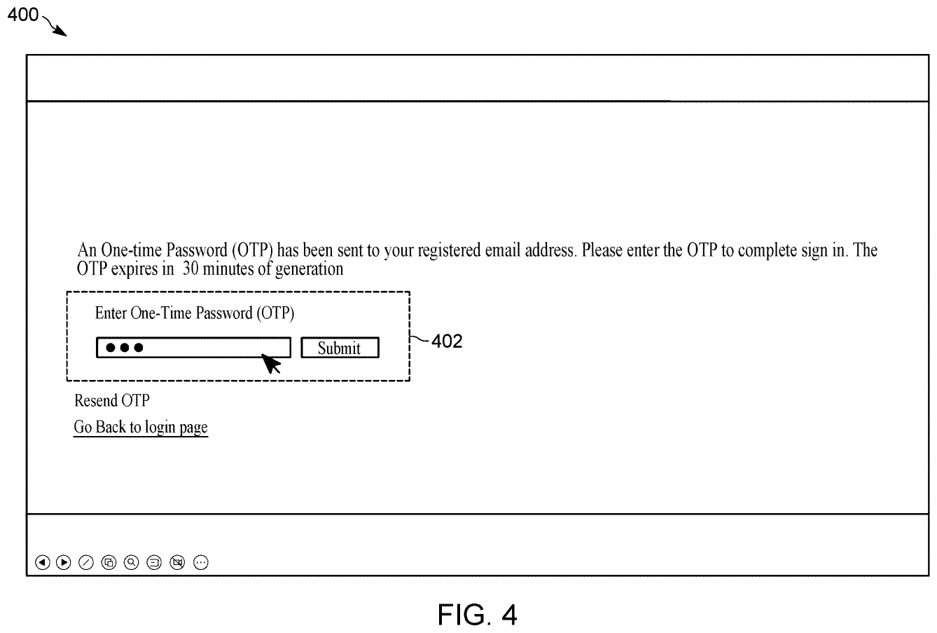

FIG. 4 illustrates a multi-step authentication page 400 of the GUI of the implementation of the present invention, in accordance with an embodiment. The multi-step authentication page 400 provides a prompt 402 to allow a user to enter a One Time Password (OTP) received at a registered email address or a registered mobile phone number.

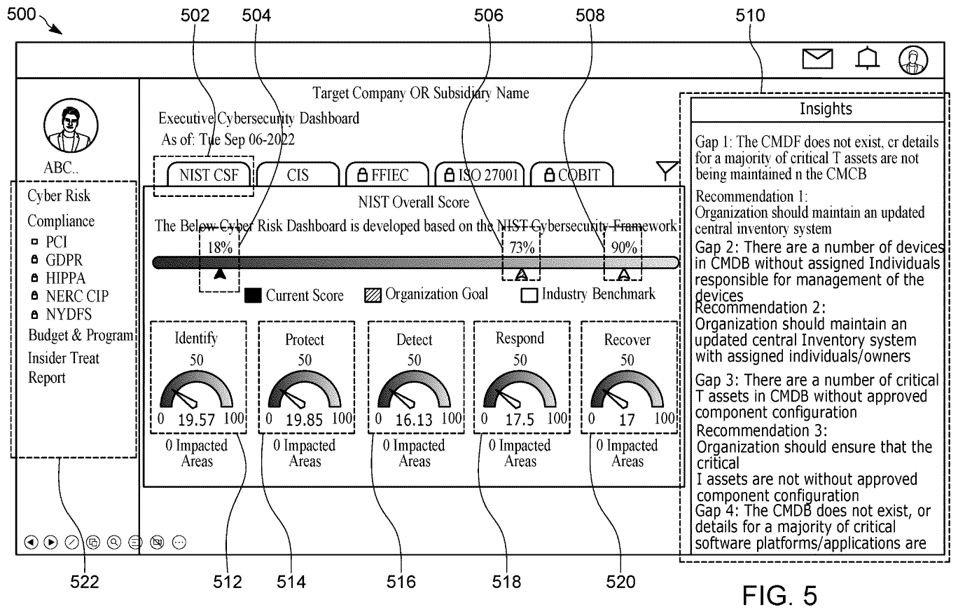

FIG. 5 illustrates an executive dashboard page 500 of the GUI of the implementation of the present invention, in accordance with an embodiment. The executive dashboard page 500 provides a high-level overview of the state of the information security infrastructure of the entity. The executive dashboard page 500 identifies a standard (NIST Cybersecurity Framework) 502 against which the information security infrastructure is being evaluated. Furthermore, a first indicator 504 indicates an overall aggregate score or security profile of the entity. A second indicator 506 indicates a target aggregate score or target security profile for the entity. Also, a third indicator 508 indicates a standard aggregate score for an industry to which the entity belongs. An Insights section 510 identifies gaps and vulnerabilities in the information security infrastructure and provides recommendations to fill in the gaps and resolve the vulnerabilities. Several pie diagrams 512, 514, 516, 518, and 520 provide aggregate scores for the highest level of classification for the applied NIST standard with five (5) functions defined as Identify, Protect, Detect, Respond, and Recover. Also, a navigation section 522 allows the user to navigate between several pages of the GUI.

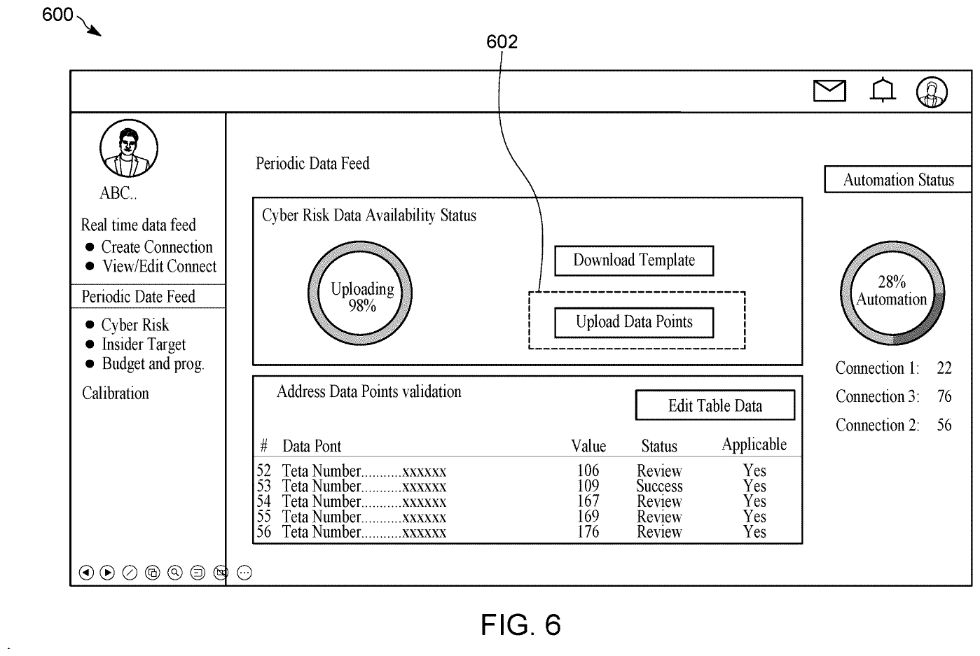

FIG. 6 illustrates a configuration manager page 600 of the GUI of the implementation of the present invention, in accordance with an embodiment. An interface element 602 allows a user to upload data depending upon predefined cybersecurity data points. The configuration manager may be upgraded by providing functionalities like automation, system integration, product calibration, etc.

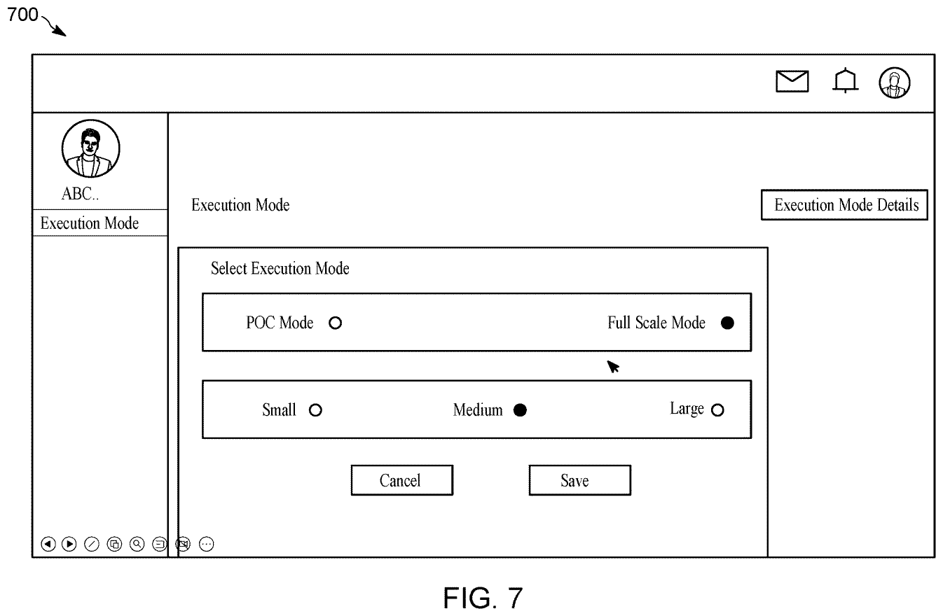

FIG. 7 illustrates a super administrator page 700 of the GUI of the implementation of the present invention, in accordance with an embodiment. The super administrator page 700 allows a user to define an execution mode of the invention, client onboarding, module assignment, role management, and user management.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to be providing the broadest scope consistent with the principles and the novel and inventive features disclosed or suggested herein. Accordingly, the invention is anticipated to hold on to all other such alternatives, modifications, and variations that fall within the scope of the present invention and appended claims.

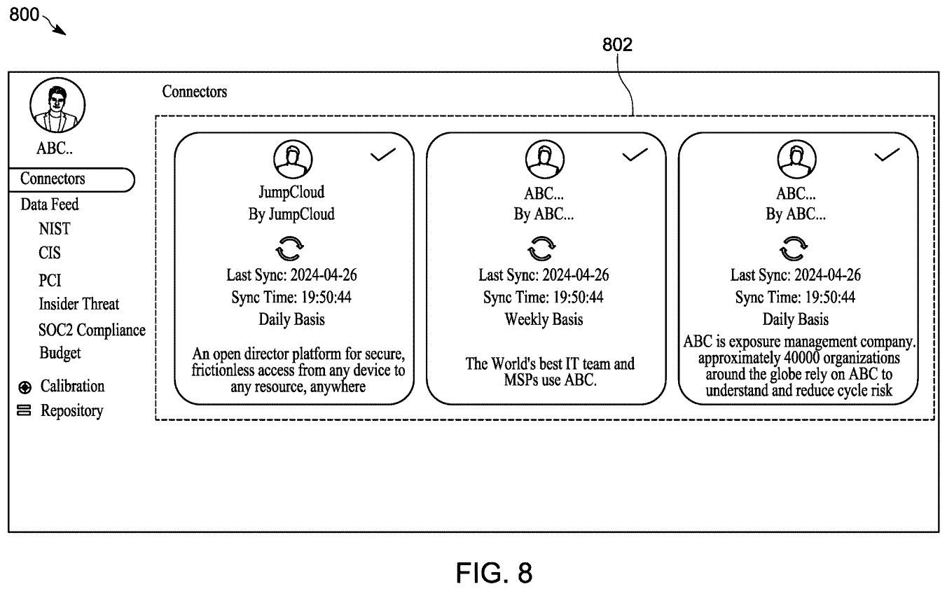

FIG. 8 illustrates a connector capabilities page 800 of the GUI of the implementation of the present invention, in accordance with an embodiment. The connector capabilities page 800 provides an interface for users to manage and configure various connectors that automatically pull data from multiple information source systems. These connectors facilitate seamless integration and data aggregation from various platforms, enhancing the efficiency and comprehensiveness of the information security infrastructure assessment.

The connector capabilities page 800 may include a connector list section 802 that displays a list of available connectors. Each connector in the list is identified by its source system, such as JumpCloud, NinjaOne, and Tenable. Each connector entry provides a brief description of the source system and the type of data it pulls. This section allows users to enable or disable connectors based on their specific needs.

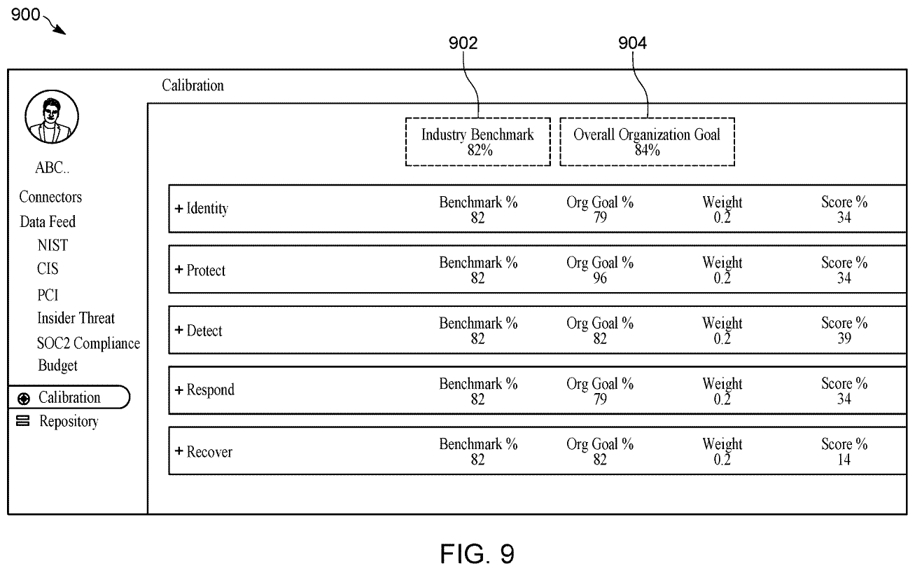

FIG. 9 illustrates a calibration capability page 900 of the GUI of the implementation of the present invention, in accordance with an embodiment. The calibration capability page 900 provides an interface that enables users to customize and calibrate the information security infrastructure assessment process according to their organization's specific goals and benchmarks. This page ensures that the assessment is tailored to the unique needs and objectives of each organization, rather than applying a one-size-fits-all approach.

The calibration capability page 900 may include a benchmarking section 902 where users can set benchmarks for various Key Risk Indicators (KRIs). This section allows users to compare their organization's performance against industry standards or predefined benchmarks.

Users can select specific industry standards, such as NIST or ISO, and input custom benchmark values for each KRI. This helps in establishing a relevant context for evaluating the organization's security posture.

The goal setting panel 904 enables users to define organizational goals for their information security infrastructure. This panel allows users to set target values for KRIs, which reflect the desired state of security controls within the organization.

Users can specify both short-term and long-term goals, providing a clear roadmap for security improvements. The panel also includes options for setting deadlines and assigning responsibility for achieving these goals.

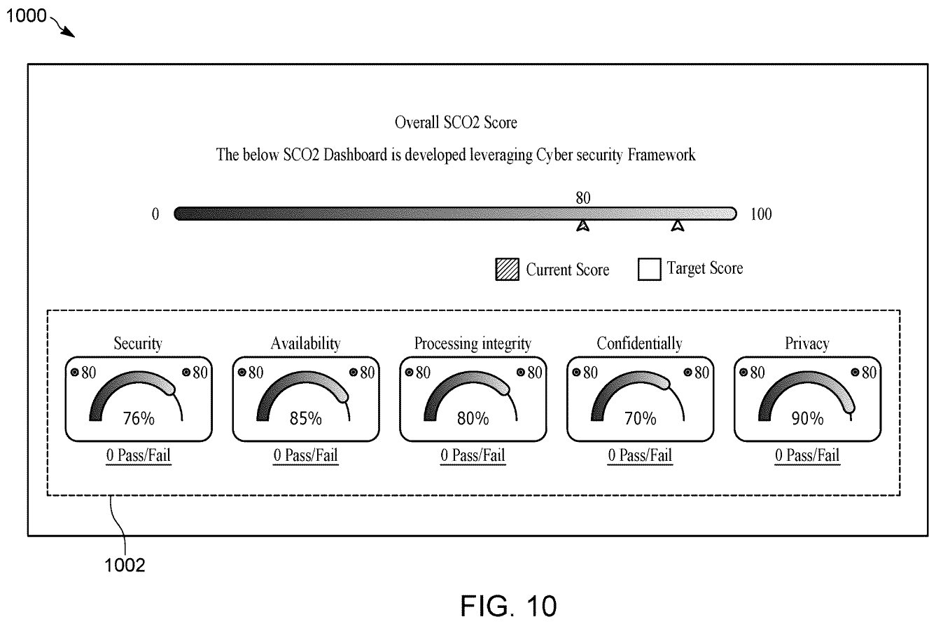

FIG. 10 illustrates a service organization control (SOC2) readiness capability page 1000 of the GUI of the implementation of the present invention, in accordance with an embodiment. The SOC2 readiness capability page 1000 provides a comprehensive interface designed to assist organizations in preparing for SOC2 compliance. This page streamlines the process of evaluating and enhancing the organization's information security practices to meet SOC2 requirements. The SOC2 readiness capability page 1000 may include a readiness assessment section 1002.

The readiness assessment section 1002 allows users to conduct a detailed assessment of their current compliance status. This section includes a checklist of SOC2 criteria, enabling users to systematically review and verify their adherence to the five SOC2 Trust Service Criteria: Security, Availability, Processing Integrity, Confidentiality, and Privacy. Each criterion is broken down into specific controls and practices that need to be in place, providing a clear framework for the readiness assessment.

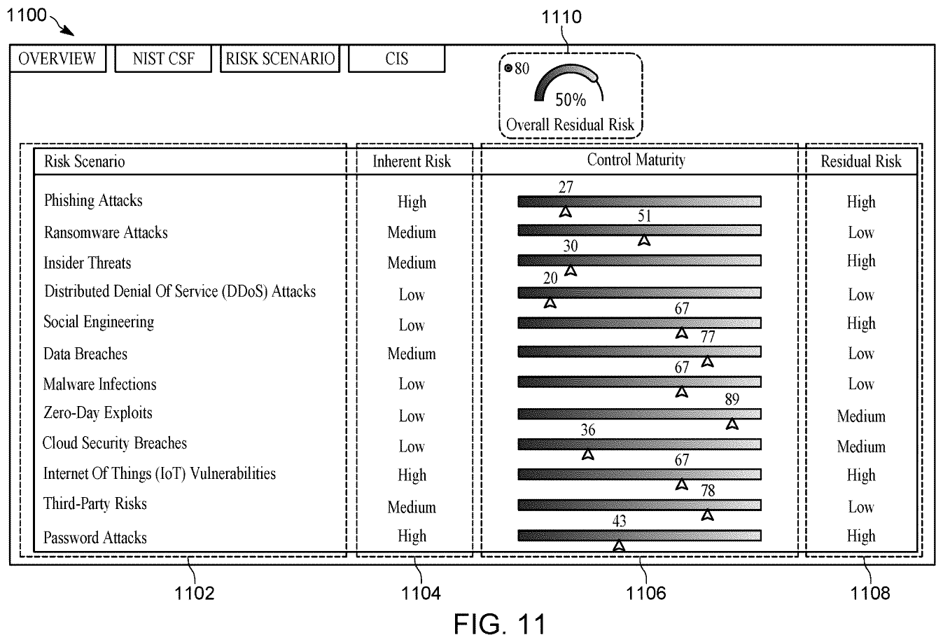

FIG. 11 illustrates a risk scenario generation capability of the GUI of the implementation of the present invention, in accordance with an embodiment. The risk scenario generation capability depicted in FIG. 11 provides users with a powerful toolset to simulate and analyze potential risk scenarios within their information security infrastructure. This functionality enhances the organization's ability to proactively identify and mitigate risks, thereby strengthening overall security posture.

The risk scenario generation capability page 1100 provides a robust and interactive interface designed to assist organizations in identifying, evaluating, and managing various risk scenarios that could impact their information security infrastructure. The risk scenario generation capability page 1100 enables users to generate and analyze risk scenarios, assess their inherent and residual risks, and evaluate control maturity. The risk scenario generation capability page 1100 may include a risk scenario definition section 1102, an inherent risk assessment panel 1104, a control maturity evaluation section 1106, a residual risk calculation panel 1108, and an overall residual risk summary section 1110.

The risk scenario definition section 1102 allows users to define and document specific risk scenarios that are relevant to their organization. Users can select from a predefined list of common risk scenarios or create custom scenarios tailored to their unique environment. Examples of predefined risk scenarios include phishing attacks, ransomware attacks, insider threats, distributed denial of service (DDoS) attacks, social engineering, data breaches, malware infections, zero-day exploits, cloud security breaches, Internet of Things (IoT) vulnerabilities, third-party risks, and password attacks.

The inherent risk assessment panel 1104 enables users to evaluate the inherent risk associated with each defined scenario. This panel includes criteria for assessing the likelihood and impact of each risk scenario, resulting in an inherent risk rating (e.g., high, medium, or low). Users can utilize this panel to understand the raw risk level before any controls are applied, providing a baseline for further analysis.

The control maturity evaluation section 1106 allows users to assess the maturity of existing controls related to each risk scenario. This section includes a detailed evaluation of control effectiveness, coverage, and robustness. Users can rate the maturity of controls on a scale (e.g., immature, developing, mature) to determine how well the current controls mitigate the identified risks.

The residual risk calculation panel 1108 calculates the residual risk for each scenario after considering the effectiveness of the implemented controls. This panel compares the inherent risk with the control maturity ratings to determine the remaining risk level. The residual risk is expressed in similar terms as the inherent risk (e.g., high, medium, low), helping users understand the effectiveness of their risk mitigation efforts.

The overall residual risk summary section 1110 provides an aggregate view of the residual risks across all defined scenarios. The aggregate view includes: An overall residual risk score, which is a composite score reflecting the residual risk across all scenarios. Visual indicators, such as heat maps or charts, highlight high-risk areas and prioritize mitigation efforts.

1. A computer implemented method for maintaining information security infrastructure of an entity, the computer implemented method comprising:
accessing a cascading classification schema comprising a plurality of levels of classifications indicative of critical security controls for the information security infrastructure,
wherein each of the plurality of levels of classifications comprising one or more classes defined by one or more respective class definitions, wherein each of the plurality of levels of classifications further comprising at least:
a penultimate level of classification comprising one or more penultimate level classes, and
a lowest level of classification comprising one or more lowest level classes assigned to the one or more penultimate level classes,
wherein the one or more lowest level classes are assigned one or more respective lowest level weight values, one or more respective first lowest level threshold values, and one or more respective second lowest level threshold values, and
wherein the one or more penultimate level classes are assigned one or more respective penultimate level weight values, one or more respective first penultimate level threshold values, and one or more respective second penultimate level threshold values;
identifying a plurality of Key Risk Indicators (KRIs) and assigning a plurality of respective KRI weight values, a plurality of respective first KRI threshold values, and a plurality of respective second KRI threshold values to the plurality of respective KRIs, based on the accessed cascading classification schema;
assigning the plurality of KRIs to the lowest level of classification, wherein each of the one or more lowest level classes is assigned at least one KRI;
defining a plurality of data points corresponding to the plurality of KRIs, wherein each one of the plurality of KRIs has been assigned at least one datapoint;
determining a plurality of KRI score values corresponding to the plurality of respective KRIs by comparing a plurality of respective data values associated with the plurality of respective data points, with the plurality of first KRI threshold values and the plurality of second KRI threshold values; and
determining a cascading schema of aggregate scores comprising a plurality of levels of aggregate scores, wherein the plurality of levels of aggregate scores comprises at least:
a lowest level of aggregate scores corresponding to the lowest level of classification, the lowest level of aggregate scores comprising one or more lowest level aggregate scores, such that, for a lowest level class a respective lowest level aggregate score is determined by comparing a weighted average of one or more KRI score values associated with respective one or more KRIs belonging to the lowest level class with a first lowest level threshold value and a second lowest level threshold value associated with the lowest level class, and
a penultimate level of aggregate scores corresponding to the penultimate level of classification, the penultimate level of aggregate scores comprising one or more penultimate level aggregate scores, such that, for a penultimate level class a respective penultimate level aggregate score determined by comparing a weighted average of one or more lowest level aggregate scores associated with respective one or more lowest level classes belonging to the penultimate level class with a first penultimate level threshold value and a second penultimate level threshold value associated with the penultimate level class.

2. The computer implemented method of claim 1, wherein the cascading classification schema is accessed from an information security standard defined by a Standard Setting Organization.

3. The computer implemented method of claim 1, further comprising displaying the one or more penultimate level classes with the one or more penultimate level aggregate scores in a first Graphic User Interface component, through a display unit of a user computing device.

4. The computer implemented method of claim 1, further comprising displaying the one or more lowest level classes with the one or more lowest level aggregate scores in a second GUI component, through a display unit of a user computing device.

5. The computer implemented method of claim 1, further comprising:
determining one or more highest level aggregate score values corresponding to respective one or more highest level classes of a highest level of classification of the cascading classification schema;
assigning one or more highest level weights, a first overall threshold value, and a second overall threshold value to the respective one or more highest level classes; and
determining an overall aggregate score by comparing a weighted average of the one or more highest level aggregate scores with the first overall threshold value and the second overall threshold value.

6. The computer implemented method of claim 5, further comprising displaying, on a display unit, the determined current overall aggregate score along with a target overall aggregate score and a standard overall aggregate score for an industry to which the entity belongs.

7. A computer system for maintaining information security infrastructure of an entity, the computer system comprising:
a processor; and
a memory unit operably connected to the processor, the memory unit comprising machine readable instructions, that when executed by the processor, enable the processor to:
access a cascading classification schema comprising a plurality of levels of classifications indicative of critical security controls for the information security infrastructure, each one the plurality of levels of classifications comprising one or more classes defined by one or more respective class definitions, the plurality of levels of classifications further comprising at least:
a penultimate level of classification comprising one or more penultimate level classes, and
a lowest level of classification comprising one or more lowest level classes assigned to the one or more penultimate level classes,
wherein the one or more lowest level classes are assigned one or more respective lowest level weight values, one or more respective first lowest level threshold values, and one or more respective second lowest level threshold values, and
wherein the one or more penultimate level classes are assigned one or more respective penultimate level weight values, one or more respective first penultimate level threshold values, and one or more respective second penultimate level threshold values;
identify a plurality of Key Risk Indicators (KRIs) and assign a plurality of respective KRI weight values, a plurality of respective first KRI threshold values, and a plurality of respective second KRI threshold values to the plurality of respective KRIs, based on the accessed cascading classification schema;
assign the plurality of KRIs to the lowest level of classification, wherein each lowest level class is assigned at least one KRI;
define a plurality of data points corresponding to the plurality of KRIs, wherein each one of the plurality of KRIs has been assigned at least one datapoint;
determine a plurality of KRI score values corresponding to the plurality of respective KRIs by comparing a plurality of respective data values associated with the plurality of respective data points, with the plurality of first KRI threshold values and the plurality of second KRI threshold values; and
determine a cascading schema of aggregate scores comprising a plurality of levels of aggregate scores, wherein the plurality of levels of aggregate scores comprises at least:
a lowest level of aggregate scores corresponding to the lowest level of classification, the lowest level of aggregate scores comprising one or more lowest level aggregate scores, such that, for a lowest level class a respective lowest level aggregate score is determined by comparing a weighted average of one or more KRI score values associated with respective one or more KRIs belonging to the lowest level class with a first lowest level threshold value and a second lowest level threshold value associated with the lowest level class, and
a penultimate level of aggregate scores corresponding to the penultimate level of classification, the penultimate level of aggregate scores comprising one or more penultimate level aggregate scores, such that, for a penultimate level class a respective penultimate level aggregate score determined by comparing a weighted average of one or more lowest level aggregate scores associated with respective one or more lowest level classes belonging to the penultimate level class with a first penultimate level threshold value and a second penultimate level threshold value associated with the penultimate level class.

8. The computer system of claim 7, wherein the processor is enabled to access the cascading classification schema from an information security standard defined by a Standard Setting Organization (SSO) server.

9. The computer system of claim 7, wherein the processor is further enabled to display the one or more penultimate level classes with the one or more penultimate level aggregate scores in a first Graphic User Interface (GUI) component, through a display unit of a user computing device.

10. The computer system of claim 7, wherein the processor is further enabled to display the one or more lowest level classes with the one or more lowest level aggregate scores in a second GUI component, through a display unit of a user computing device.

11. The computer system of claim 7, wherein the processor is further enabled to:
determine one or more highest level aggregate score values corresponding to respective one or more highest level classes of a highest level of classification of the cascading classification schema;
assign one or more highest level weights, a first overall threshold value, and a second overall threshold value to the respective one or more highest level classes; and
determine an overall aggregate score by comparing a weighted average of the one or more highest level aggregate scores with the first overall threshold value and the second overall threshold value.

12. The computer system of claim 11, wherein the processor is further enabled to display, on a display unit, the determined current overall aggregate score along with a target overall aggregate score and a standard overall aggregate score for an industry to which the entity belongs.

13. A non-transitory computer-readable medium storing computer-executable instructions for maintaining information security infrastructure of an entity, the computer-executable instructions configured for:
accessing a cascading classification schema comprising a plurality of levels of classifications indicative of critical security controls for the information security infrastructure,
wherein each of the plurality of levels of classifications comprising one or more classes defined by one or more respective class definitions, wherein each of the plurality of levels of classifications further comprising at least:
a penultimate level of classification comprising one or more penultimate level classes, and
a lowest level of classification comprising one or more lowest level classes assigned to the one or more penultimate level classes,
wherein the one or more lowest level classes are assigned one or more respective lowest level weight values, one or more respective first lowest level threshold values, and one or more respective second lowest level threshold values, and
wherein the one or more penultimate level classes are assigned one or more respective penultimate level weight values, one or more respective first penultimate level threshold values, and one or more respective second penultimate level threshold values;
identifying a plurality of Key Risk Indicators (KRIs) and assigning a plurality of respective KRI weight values, a plurality of respective first KRI threshold values, and a plurality of respective second KRI threshold values to the plurality of respective KRIs, based on the accessed cascading classification schema;
assigning the plurality of KRIs to the lowest level of classification, wherein each of the one or more lowest level classes is assigned at least one KRI;
defining a plurality of data points corresponding to the plurality of KRIs, wherein each one of the plurality of KRIs has been assigned at least one datapoint;
determining a plurality of KRI score values corresponding to the plurality of respective KRIs by comparing a plurality of respective data values associated with the plurality of respective data points, with the plurality of first KRI threshold values and the plurality of second KRI threshold values; and
determining a cascading schema of aggregate scores comprising a plurality of levels of aggregate scores, wherein the plurality of levels of aggregate scores comprises at least:
a lowest level of aggregate scores corresponding to the lowest level of classification, the lowest level of aggregate scores comprising one or more lowest level aggregate scores, such that, for a lowest level class a respective lowest level aggregate score is determined by comparing a weighted average of one or more KRI score values associated with respective one or more KRIs belonging to the lowest level class with a first lowest level threshold value and a second lowest level threshold value associated with the lowest level class, and
a penultimate level of aggregate scores corresponding to the penultimate level of classification, the penultimate level of aggregate scores comprising one or more penultimate level aggregate scores, such that, for a penultimate level class a respective penultimate level aggregate score determined by comparing a weighted average of one or more lowest level aggregate scores associated with respective one or more lowest level classes belonging to the penultimate level class with a first penultimate level threshold value and a second penultimate level threshold value associated with the penultimate level class.

14. The non-transitory computer-readable medium of claim 13, wherein the cascading classification schema is accessed from an information security standard defined by a Standard Setting Organization (SSO).

15. The non-transitory computer-readable medium of claim 13, wherein the computer-executable instructions are further configured for:
displaying the one or more penultimate level classes with the one or more penultimate level aggregate scores in a first Graphic User Interface (GUI) component, through a display unit of a user computing device.

16. The non-transitory computer-readable medium of claim 13, wherein the computer-executable instructions are further configured for:
displaying the one or more lowest level classes with the one or more lowest level aggregate scores in a second GUI component, through a display unit of a user computing device.

17. The non-transitory computer-readable medium of claim 13, wherein the computer-executable instructions are further configured for:
determining one or more highest level aggregate score values corresponding to respective one or more highest level classes of a highest level of classification of the cascading classification schema;
assigning one or more highest level weights, a first overall threshold value, and a second overall threshold value to the respective one or more highest level classes; and
determining an overall aggregate score by comparing a weighted average of the one or more highest level aggregate scores with the first overall threshold value and the second overall threshold value.

18. The non-transitory computer-readable medium of claim 17, wherein the computer-executable instructions are further configured for:
displaying, on a display unit, the determined current overall aggregate score along with a target overall aggregate score and a standard overall aggregate score for an industry to which the entity belongs.
